(19) United States
(12) Patent Application Publication
(10) Pub. No.: US 2025/0251327 A1
(43) Pub. Date: Aug. 7, 2025

(54) ANALYSIS APPARATUS, ANALYSIS METHOD, AND NON-TRANSITORY COMPUTER-READABLE MEDIUM

(71) Applicants: NEC Corporation, Tokyo (JP); TOHOKU UNIVERSITY, Sendai-shi (JP); TOKYO SEIKO ROPE MFG.CO., LTD., Gamagori-shi (JP)

(72) Inventors: Tomoya Soma, Tokyo (JP); Tetsuya Uchimoto, Miyagi (JP); Sho Takeda, Miyagi (JP); Kazuki Sasada, Miyagi (JP); Makoto Kimura, Aichi (JP)

(73) Assignees: NEC Corporation, Tokyo (JP); TOHOKU UNIVERSITY, Sendai-shi (JP); TOKYO SEIKO ROPE MFG.CO., LTD., Gamagori-shi (JP)

(21) Appl. No.: 19/044,034

(22) Filed: Feb. 3, 2025

(30) Foreign Application Priority Data
Feb. 6, 2024 (JP) 2024-016676

(51) Int. Cl. G01N 3/32; G01N 3/56

(52) U.S. Cl. CPC G01N 3/32; G01N 3/56; G01N 2203/0007; G01N 2203/0017; G01N 2203/0252; G01N 2203/028; G01N 2203/0658

(57) ABSTRACT

To provide an analysis apparatus, an analysis method, and a program that are non-destructively analyze a degree of damage of a fiber rope, an analysis apparatus includes an analysis unit that analyzes the degree of damage of the fiber rope by using an invariant model indicating a relationship between a plurality of pieces of time-series data based on measurement data of one or more sensors attached to or around the fiber rope.

### INCORPORATION BY REFERENCE

This application is based upon and claims the benefit of priority from Japanese patent application No. 2024-016676, filed on Feb. 6, 2024, the disclosure of which is incorporated herein in its entirety by reference.

### TECHNICAL FIELD

The present disclosure relates to an analysis apparatus, an analysis method, and a program.

### BACKGROUND ART

International Patent Publication No. WO2023/105546 describes a technique for inputting a sound emitted by a monitoring target into a model, and detecting an anomaly of the monitoring target.

### SUMMARY

Incidentally, there has been a problem that it is difficult to non-destructively analyze a degree of damage of a fiber rope.

The present disclosure has been made to solve such problem, and an example object of the present disclosure is to provide an analysis apparatus, an analysis method, and a program that non-destructively analyze a degree of damage of a fiber rope.

In a first example aspect, an analysis apparatus according to the present disclosure includes an analysis unit configured to analyze a degree of damage of a fiber rope by using an invariant model indicating a relationship between a plurality of pieces of time-series data based on measurement data of one or more sensors attached to or around the fiber rope.

In a second example aspect, an analysis method according to the present disclosure includes analyzing a degree of damage of a fiber rope by using an invariant model indicating a relationship between a plurality of pieces of time-series data based on measurement data of one or more sensors attached to or around the fiber rope.

In a third example aspect, a program according to the present disclosure causes a computer to execute processing of analyzing a degree of damage of a fiber rope by using an invariant model indicating a relationship between a plurality of pieces of time-series data based on measurement data of one or more sensors attached to or around the fiber rope.

An example advantage according to the above-described example embodiment is to provide an analysis apparatus, an analysis method, and a program that non-destructively analyze a degree of damage of a fiber rope.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram illustrating a configuration of an analysis apparatus according to the present disclosure;

FIG. 2 is a flowchart illustrating a flow of an analysis method according to the present disclosure;

FIG. 3 is a diagram for describing the configuration of the analysis apparatus according to the present disclosure;

FIG. 4 is a diagram for describing an invariant model according to the present disclosure;

FIG. 5 is a diagram for describing a method of generating time-series data according to the present disclosure;

FIG. 6 is a graph illustrating a load-time curve and the number of AE events at a time when a tensile load is applied to a fiber rope according to the present disclosure;

FIG. 7 is a graph illustrating a load-time curve and the number of AE events at a time when a tensile load is applied to the fiber rope according to the present disclosure;

FIG. 8 is a graph illustrating a load-time curve and the number of AE events at a time when a tensile load is applied to the fiber rope according to the present disclosure;

FIG. 9 is a graph illustrating a temporal change in an anomaly score at a time when a tensile load is applied to the fiber rope according to the present disclosure;

FIG. 10 is a graph illustrating the number of AE events at a time when a repeated load is applied to the fiber rope according to the present disclosure;

FIG. 11 is a graph illustrating an anomaly score and the number of AE events at a time when a repeated load is applied to the fiber rope according to the present disclosure;

FIG. 12 is a graph illustrating an anomaly score and the number of AE events at a time when a repeated load is applied to the fiber rope according to the present disclosure; and

FIG. 13 is a block diagram illustrating one example of a hardware configuration of the analysis apparatus according to the present disclosure.

### EXAMPLE EMBODIMENT

### First Example Embodiment

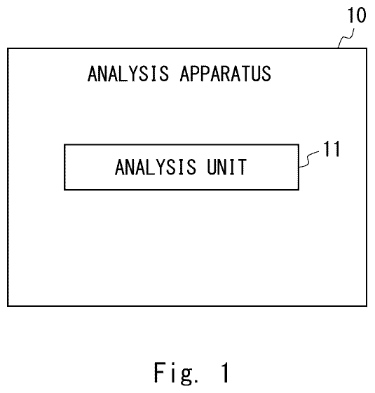

Hereinafter, a configuration example of an analysis apparatus 10 will be described with reference to FIG. 1. The analysis apparatus 10 may be a computer apparatus that operates by a processor executing a program stored in a memory. The analysis apparatus 10 may be an information processing apparatus, or may be, for example, a server apparatus. Further, the analysis apparatus 10 may be configured by a plurality of computer apparatuses. In this case, a constituent element or a function configuring the analysis apparatus 10 may be arranged in a distributed manner among the plurality of computer apparatuses. The plurality of computer apparatuses may be connected via a network, or may be directly connected via a cable or the like.

The analysis apparatus 10 includes an analysis unit 11. The analysis unit 11 may be software or a module in which processing is executed by a processor executing a program stored in a memory. Alternatively, the analysis unit 11 may be hardware such as a circuit or a chip.

The analysis unit 11 analyzes a degree of damage of a fiber rope by using an invariant model. The invariant model indicates a relationship between a plurality of pieces of time-series data based on measurement data of one or more sensors attached to or around a fiber rope. The invariant model may indicate a relationship between features of the plurality of pieces of time-series data.

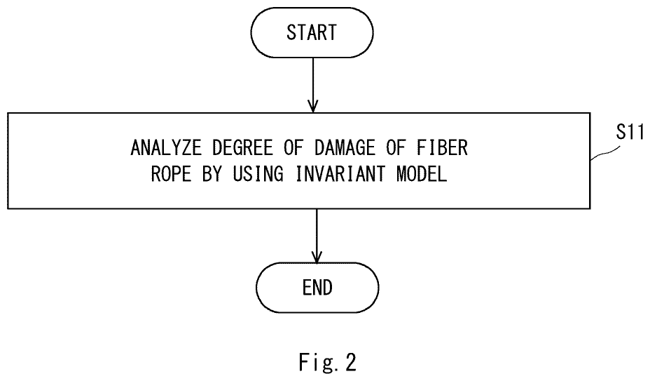

A flow of an analysis method will be described with reference to FIG. 2. In the analysis method, the analysis unit 11 analyzes a degree of damage of a fiber rope by using the invariant model (step S11).

Since the analysis apparatus 10 analyzes the degree of damage of a fiber rope by using the invariant model, the degree of damage of the fiber rope can be non-destructively analyzed.

### Second Example Embodiment

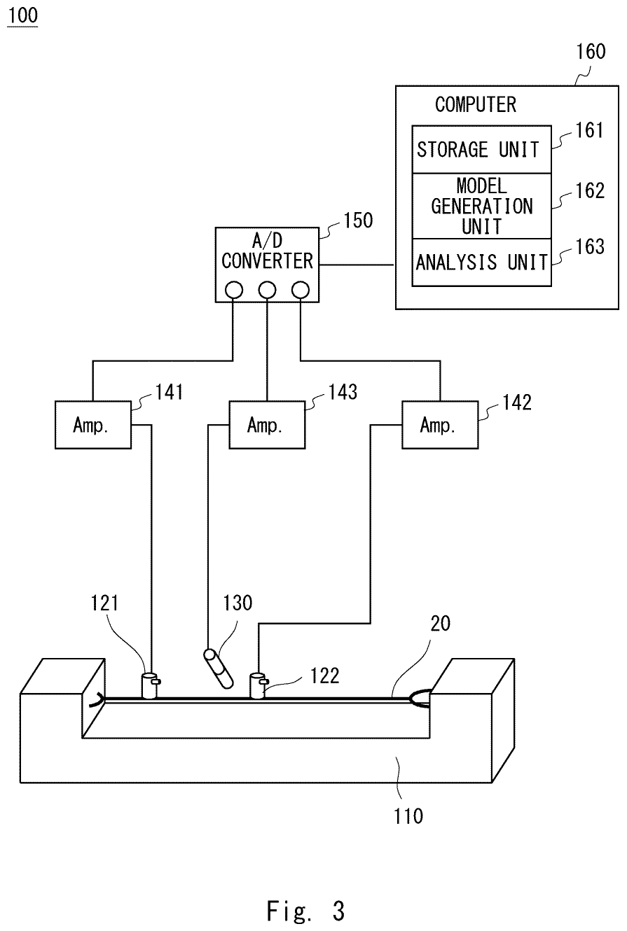

A configuration example of an analysis apparatus 100 will be described with reference to FIG. 3. The analysis apparatus 100 is a specific example of the analysis apparatus 10. The analysis apparatus 100 includes a tester 110, AE sensors 121 to 122, a microphone 130, amplifiers 141 to 143, an analog digital (A/D) converter 150, and a computer 160. Alternatively, the A/D converter 150 may be built in the computer 160.

A fiber rope 20 is attached to the tester 110. The fiber rope 20 is a rope made of a fiber. The tester 110 applies a tensile load, a repetitive load, or the like to the fiber rope 20. Note that, the fiber rope 20 used for training the invariant model may be different from the fiber rope 20 to be analyzed. Further, the number of fiber ropes 20 used for training may be plural. By training time-series measurement data of a plurality of the fiber ropes 20, performance of the invariant model can be improved. Note that, the fiber rope 20 may or may not be attached to the tester 110 and subjected to a tensile test.

The AE sensors 121 to 122 are attached to a vicinity of a part of the fiber rope 20 (referred to as a “root” in some cases) that is connected to the tester 110, and at the center of the fiber rope 20, respectively, and measure a signal by an elastic wave generated in the fiber rope 20. Each of the AE sensors 121 to 122 measures a signal by an elastic wave generated by deformation, transformation, transition, fracture, or the like of a material. In a case where the AE sensors 121 to 122 are not distinct from each other, there is a case where they may simply be referred to as an AE sensor 120. The microphone 130 is attached around the fiber rope 20, and measures an audio signal in an audible range from the fiber rope 20. The AE sensors 121 to 122 and the microphone 130 are attached at positions different from one another in an extending direction of the fiber rope 20.

A frequency domain of the microphone 130 is low compared to the frequency domain of the AE sensor 120. By using both the AE sensor 120 and the microphone 130, the analysis apparatus 100 can use information in a wider frequency domain.

Note that, as a common problem of the AE sensor 120 and the microphone 130, there is a problem that it is easily affected by noise caused by a surrounding environment or electrical noise. A second example embodiment can solve this problem by using the invariant model.

The amplifiers 141 to 143 amplify measurement signals of the AE sensor 121, the AE sensor 122, and the microphone 130, respectively. The A/D converter 150 acquires the measurement signals amplified by the amplifiers 141 to 143.

The computer 160 is, for example, a personal computer (PC), and includes a not-illustrated processor and memory. The computer 160 includes a storage unit 161, a model generation unit 162, and an analysis unit 163. The storage unit 161 is a storage medium accessible by the processor, and stores a program. Functions of the model generation unit 162 and the analysis unit 163 may be achieved by the processor executing the program read into the memory. Further, the storage unit 161 stores an invariant model to be described later.

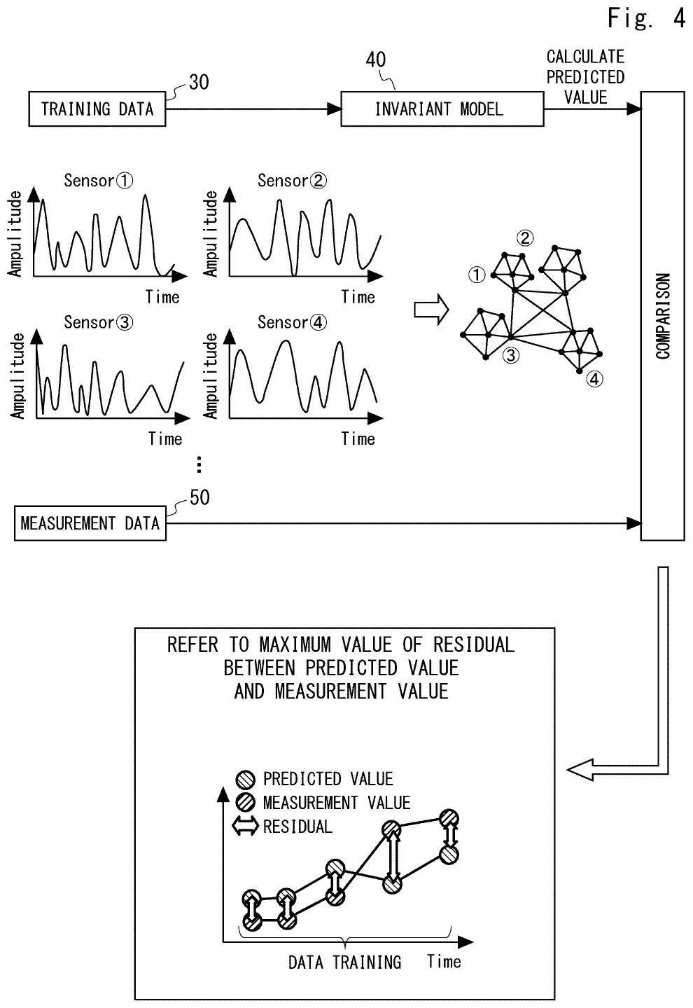

First, referring to FIG. 4, an exemplary description of a general invariant model will be given. FIG. 4 includes, as training data 30, time-series data measured by sensors 1 to 4 at a normal time. An invariant model 40 represents an invariant relationship between a plurality of pieces of time-series data. “1” to “4” in a relationship diagram representing the invariant model 40 correspond to the sensors 1 to 4, respectively. After generating the invariant model 40, actual measurement data 50 of the sensor 1 are compared with a predicted value calculated by using the invariant model 40 from measurement values of the sensors 2 to 4. Similarly, the measurement data (measurement values) of the sensors 2 to 4 are compared with the predicted value. A graph below represents a temporal change of the measurement value of any of the sensors 1 to 4 and the predicted value. An anomaly score is calculated based on a maximum value of a difference (also referred to as a residual) between the measurement value and the predicted value. The anomaly score corresponds to a degree of damage of the fiber rope 20.

Referring to FIG. 3, the model generation unit 162 generates time-series data for each frequency band by using a Fourier transform from time-series measurement data of each of the AE sensors 120 attached to the fiber rope 20 in a normal state. Similarly, the model generation unit 162 generates time-series data for each frequency band by using the Fourier transform from time-series measurement data of the microphone 130 attached around the fiber rope 20 in the normal state. Then, the model generation unit 162 generates the invariant model in which the invariant relationship between a plurality of pieces of the generated time-series data is trained. Then, the model generation unit 162 stores the generated invariant model in the storage unit 161.

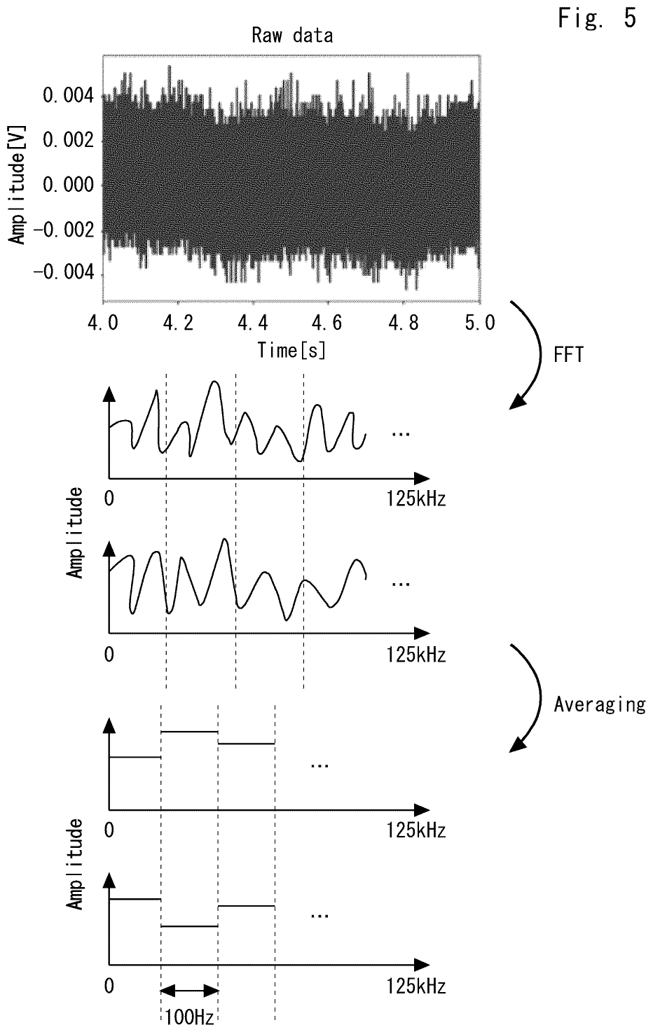

It can also be considered that the number of sensors in the invariant model is increased by generating time-series data for each frequency band by using the Fourier transform. FIG. 5 is a diagram for describing one example of a method of generating time-series data. An upper-stage diagram represents time-series measurement data (Raw data) measured by the AE sensor 120 or the microphone 130. A middle-stage diagram represents a result of performing a fast Fourier transform (FFT) on the measurement data for each time interval. The results of the FFT associated to different time intervals are arranged one above the other. Moreover, as illustrated in a lower-stage diagram, the results of the FFT are averaged for each frequency domain. A width of the frequency domain is, for example, 100 Hz. By joining averaged values in a plurality of time intervals, time-series data in the frequency domain are generated.

Referring to FIG. 3, the analysis unit 163 analyzes the degree of damage of the fiber rope 20 to be analyzed by using the invariant model. Specifically, the analysis unit 163 generates time-series data for each frequency band by using the Fourier transform from the time-series measurement data of each of the AE sensors 120 attached to the fiber rope 20 to be analyzed. Similarly, the analysis unit 163 generates time-series data for each frequency band by using the Fourier transform from the time-series measurement data of the microphone 130 attached around the fiber rope 20 to be analyzed. Then, the analysis unit 163 analyzes the degree of damage by using the invariant model from a plurality of pieces of the generated time-series data. Specifically, the analysis unit 163 calculates the degree of damage (also referred to as an anomaly score), based on a maximum value of a difference between an actual value of the time-series data and a predicted value predicted from another piece of time-series data by using the invariant model. The degree of damage may be, for example, a sum of the above-described maximum values in a plurality of pieces of time-series data.

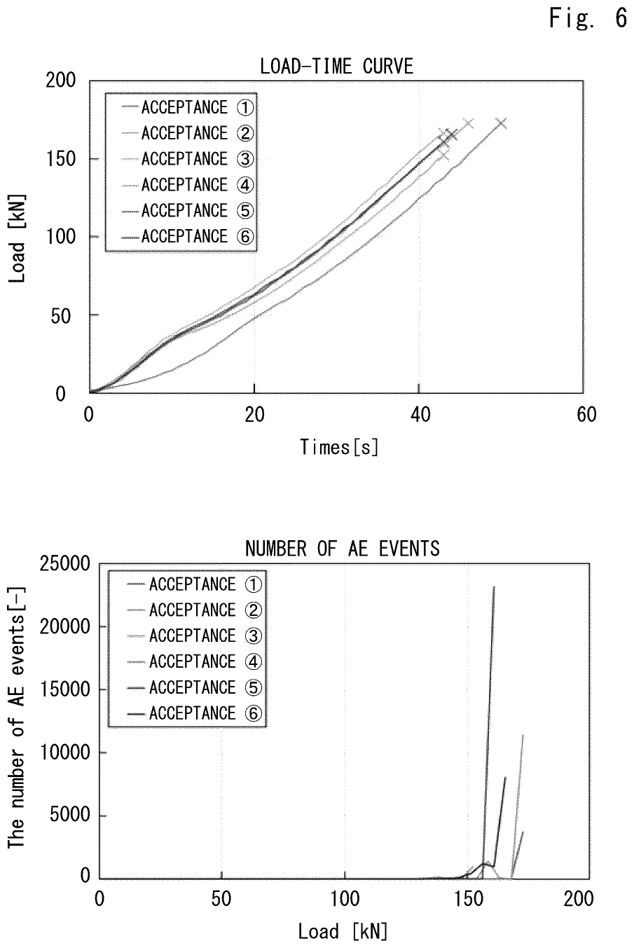

Next, an experimental result in a case where a tensile load is applied to the fiber rope 20 will be described with reference to FIGS. 6, 7, 8, and 9.

An upper diagram in FIG. 6 represents a load-time curve at a time when a tensile load is applied to six fiber ropes 20 that are acceptance test pieces. A tensile condition is 100 mm/min (displacement control). A lower diagram in FIG. 6 represents the number of AE events at a time when a tensile load is applied to six fiber ropes 20 that are acceptance test pieces. The AE event means that an AE wave having amplitude equal to or larger than a threshold value is detected by the AE sensor 120. The number of AE events at a time of fracture varies for each test piece, but timing of increase in the number of AE events coincides among test pieces.

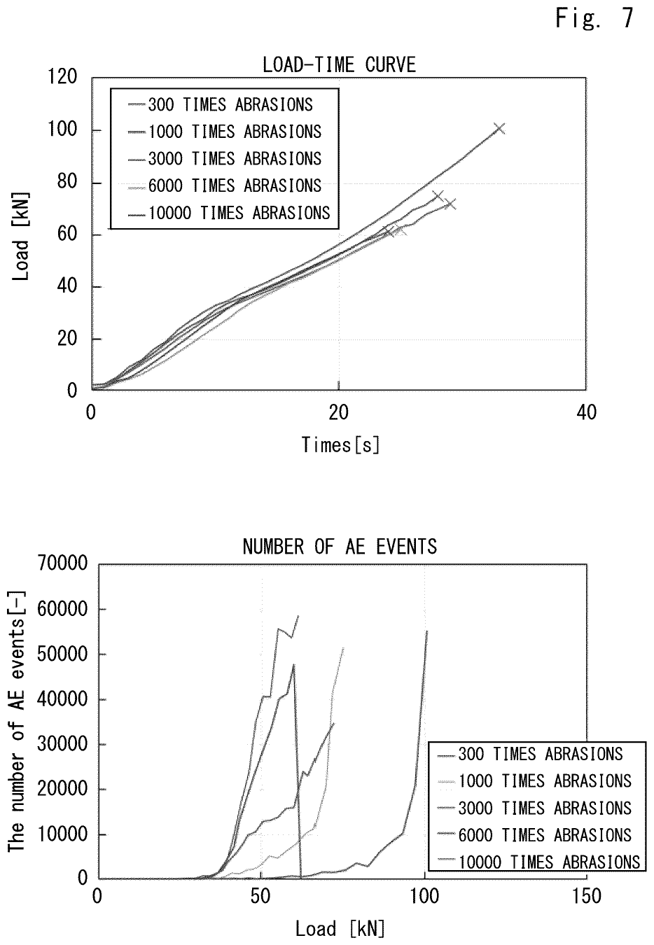

An upper diagram in FIG. 7 represents a load-time curve at a time when a tensile load is applied to five fiber ropes 20 that are abrasion test pieces. The number of times of abrasions is different among the abrasion test pieces. A lower diagram in FIG. 7 represents the number of AE events at a time when a tensile load is applied to five fiber ropes 20 that are abrasion test pieces. Referring to the upper diagram, a fracture load is reduced by increasing the number of times of abrasions. Referring to the lower diagram, timing of increase in the number of AE events approximately coincides among the test pieces regardless of the number of times of abrasions.

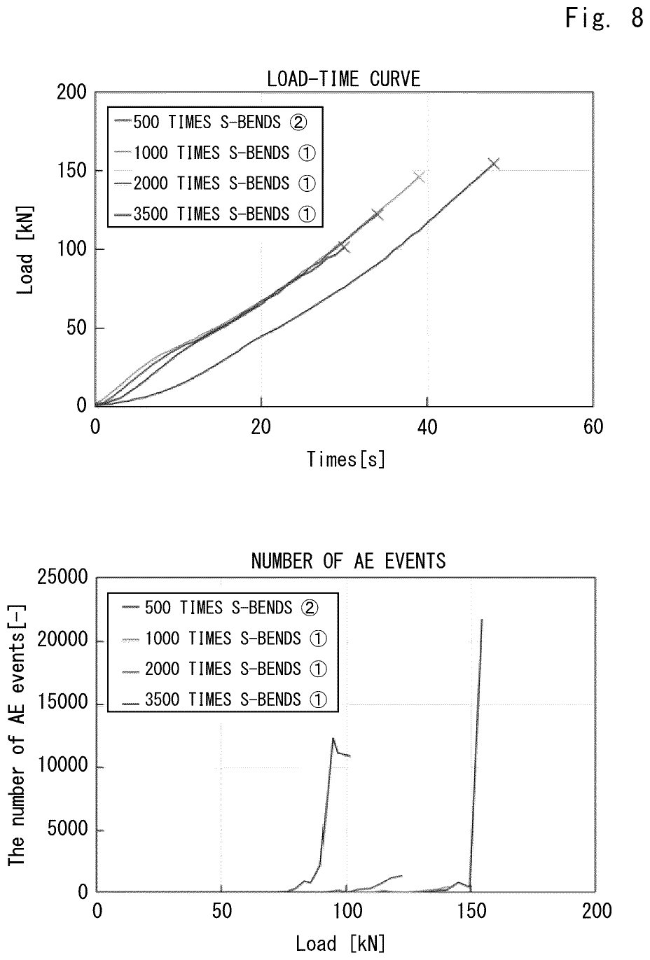

An upper diagram in FIG. 8 represents a load-time curve at a time when a tensile load is applied to four fiber ropes 20 that are S-bend test pieces. The number of times of S-bends is different among the S-bend test pieces. A lower diagram in FIG. 8 represents the number of AE events at a time when a tensile load is applied to four fiber ropes 20 that are S-bend test pieces. Referring to the upper diagram in FIG. 8, it has been confirmed that the fracture load is reduced by increasing the number of times of S-bends. Referring to the lower diagram in FIG. 8, although the number of AE events varies, it is considered that this is due to timing of test start.

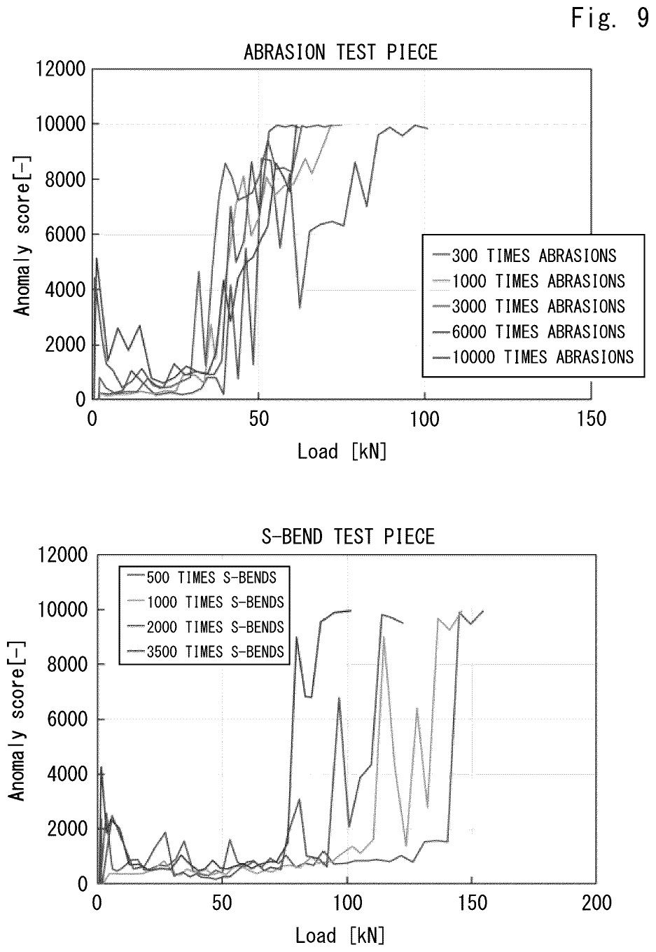

FIG. 9 illustrates a calculation result of an anomaly score based on an experimental result. A result in a period (0 to 37 seconds) during which no AE event occurs in the acceptance test piece described above has been used as training data. An upper diagram in FIG. 9 is a graph illustrating an anomaly score (degree of damage) at a time when a tensile load is applied to the abrasion test piece described above. The anomaly scores at a time of fracture of the abrasion test pieces having the different number of times of abrasions fall within a certain range, and changes in the anomaly scores of the abrasion test pieces having the different number of times of abrasions are similar to each other. Therefore, it is considered that the fracture of the fiber rope 20 can be predicted by using the anomaly score.

A lower diagram in FIG. 9 is a graph illustrating an anomaly score (degree of damage) at a time when a tensile load is applied to the S-bend test piece described above. The anomaly scores (degree of damage) at a time of fracture of the S-bend test pieces having the different number of times of S-bends fall within a certain range, and changes in the anomaly scores of the S-bend test pieces having the different number of times of S-bends are similar to each other. Therefore, the fracture of the fiber rope 20 can be predicted by using the anomaly score.

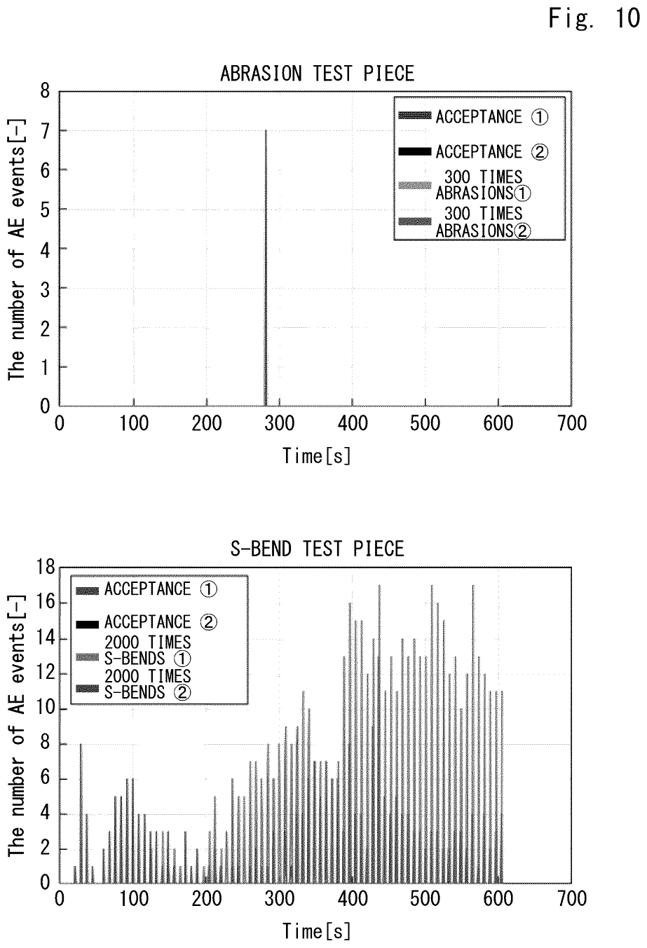

Next, an experimental result in a case where a repeated load is applied to the fiber rope 20 will be described with reference to FIGS. 10, 11, and 12.

An upper diagram in FIG. 10 illustrates a temporal change in the number of AE events in a case where a repeated load is applied to an abrasion test piece. A lower diagram in FIG. 10 represents the temporal change in the number of AE events in a case where a repeated load is applied to an S-bend test piece. It is assumed that a maximum load is set at 15% of standard strength of the fiber rope 20, a minimum load is set at 2% of the standard strength, a frequency is set at 0.125 Hz, and the number of times of repetitions is set at 75 times (10 minutes). An AE event has not occurred in an acceptance test piece, a slight AE event has occurred in the abrasion test piece, and an increase in the number of AE events has observed in the S-bend test piece.

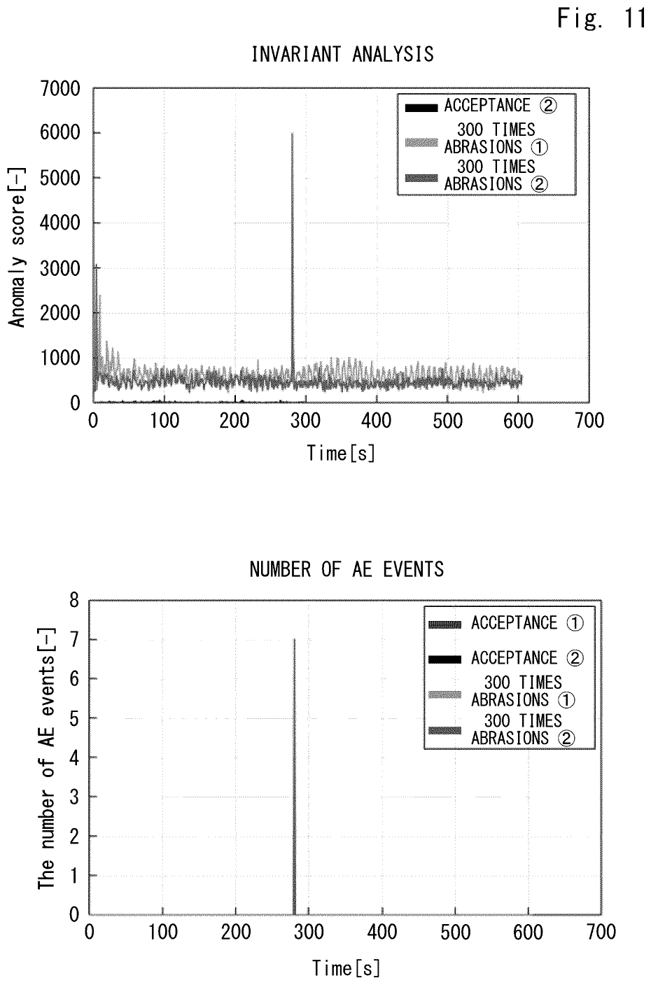

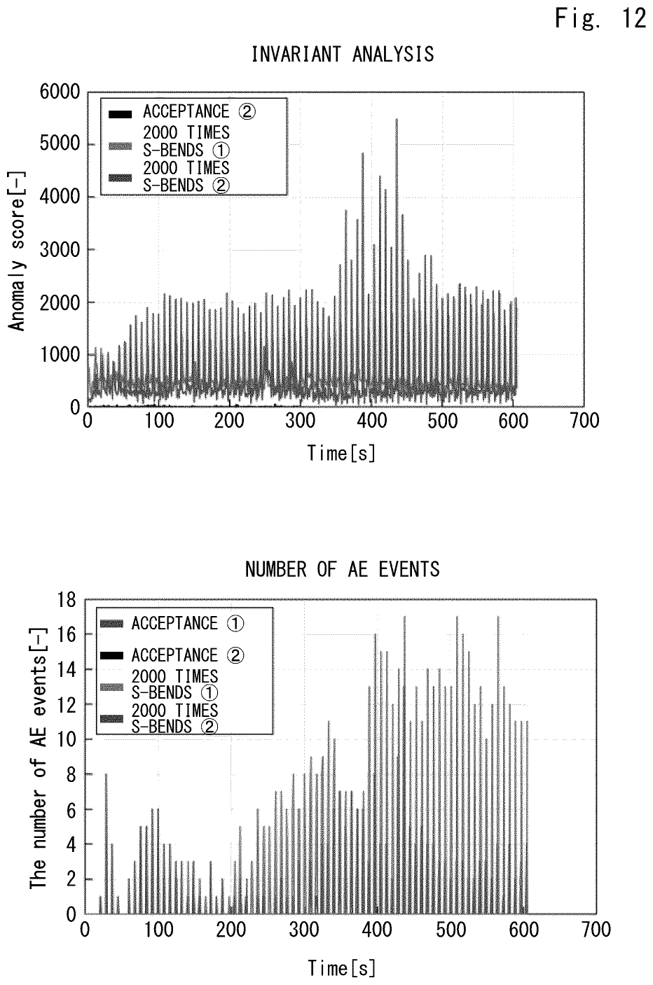

FIGS. 11 and 12 illustrate calculation results of the anomaly score. Measurement data of the acceptance test piece has been used as training data.

An upper diagram in FIG. 11 represents the temporal change in the anomaly score (degree of damage) in a case where a repeated load is applied to an abrasion test piece. A lower diagram in FIG. 11 represents the temporal change in the number of AE events in a case where a repeated load is applied to the abrasion test piece. Since there is a small peak with the anomaly score at a time before a time when an increase in the AE event is detected, there is a possibility that the analysis apparatus 100 can detect damage that cannot be detected from the number of AE events.

An upper diagram in FIG. 12 represents the temporal change in the anomaly score (degree of damage) in a case where a repeated load is applied to an S-bend test piece. A lower diagram in FIG. 12 represents the temporal change in the number of AE events in a case where a repeated load is applied to the S-bend test piece. There is a small peak with the anomaly score at a time before a time when the number of AE events increases, and there is a possibility that the analysis apparatus 100 can detect damage that cannot be detected from the number of AE events.

Since a damage mechanism of a fiber rope is unknown and there is no standard on replacement timing, a technique for non-destructively analyzing a degree of damage of the fiber rope has been desired. In the second example embodiment, the degree of damage of the fiber rope can be non-destructively analyzed by using the invariant model.

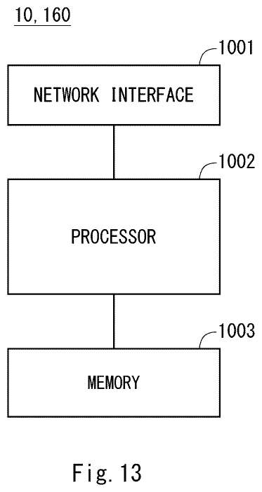

FIG. 13 is a block diagram illustrating a configuration example of the analysis apparatus 10 and the computer 160 (hereinafter, referred to as the analysis apparatus 10 and the like) described in the example embodiments described above. Referring to FIG. 13, the analysis apparatus 10 and the like include a network interface 1001, a processor 1002, and a memory 1003. The network interface 1001 may be used for communicating with a network node. The network interface 1001 may include, for example, a network interface card (NIC) compliant with IEEE 802.3 series. IEEE represent Institute of Electrical and Electronics Engineers.

The processor 1002 reads and executes software (a computer program) from the memory 1003, and thereby performs processing of the analysis apparatus 10 and the like described with reference to the flowchart in the example embodiments described above. The processor 1002 may be, for example, a microprocessor, an MPU, or a CPU. The processor 1002 may include a plurality of processors.

The memory 1003 is configured by a combination of a volatile memory and a non-volatile memory. The memory 1003 may include a storage arranged apart from the processor 1002. In this case, the processor 1002 may access the memory 1003 via a not-illustrated input/output (I/O) interface.

In the example in FIG. 13, the memory 1003 is used for storing software modules. The processor 1002 reads these software modules from the memory 1003 and executes the read software modules, and thereby can perform the processing of the analysis apparatus 10 and the like described in the example embodiments described above.

As described with reference to FIG. 13, each of the processors included in the analysis apparatus 10 and the like in the example embodiments described above executes one or a plurality of programs including instructions for causing a computer to perform algorithm described with reference to the drawings.

In the examples described above, the program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Although the present disclosure has been described with reference to the example embodiments, the present disclosure is not limited to the above-described example embodiments. Various changes that can be understood by a person skilled in the art within the scope of the present disclosure can be made to the configuration and details of the present disclosure. Then, each example embodiment can be combined with other example embodiments as appropriate.

Each drawing is merely illustrative of one or more example embodiments. Each drawing may be associated with one or more other example embodiments, rather than only one particular example embodiment. As those skilled in the art will appreciate, various features or steps described with reference to any one of the drawings may be combined with features or steps illustrated in one or more other figures, for example, to generate an example embodiment not explicitly illustrated or described. All of the features or steps illustrated in any one of the figures to describe the example embodiments are not necessarily essential, and some features or steps may be omitted. The order of the steps described in any of the figures may be changed as appropriate.

Some or all of the elements (e.g., a configuration and a function) described in supplementary notes 2 to 5 depending on supplementary note 1 may be dependent on supplementary notes 6 and 10 in dependency similar to that of supplementary notes 2 to 5. Some or all of the elements described in any supplementary note may be applied to various hardware, software, recording means for recording software, systems, and methods.

Some or all of the above-described example embodiments may be described as the following supplementary notes, but are not limited thereto.

### Supplementary Note 1

An analysis apparatus including an analysis unit configured to analyze a degree of damage of a fiber rope by using an invariant model indicating a relationship between a plurality of pieces of time-series data based on measurement data of one or more sensors attached to or around the fiber rope.

### Supplementary Note 2

The analysis apparatus according to supplementary note 1, wherein the analysis unit further generates the plurality of pieces of time-series data by generating time-series data for each frequency band from measurement data of each sensor by using a Fourier transform.

### Supplementary Note 3

The analysis apparatus according to supplementary note 1 or 2, wherein the one or more sensors include an acoustic emission (AE) sensor attached to the fiber rope, and a microphone attached around the fiber rope.

### Supplementary Note 4

The analysis apparatus according to supplementary note 3, wherein the one or more sensors are attached at positions different from each other in an extending direction of the fiber rope.

### Supplementary Note 5

The analysis apparatus according to supplementary note 1, wherein a repeated loaded is applied to the fiber rope.

### Supplementary Note 6

An analysis method including analyzing a degree of damage of a fiber rope by using an invariant model indicating a relationship between a plurality of pieces of time-series data based on measurement data of one or more sensors attached to or around the fiber rope.

### Supplementary Note 7

The analysis method according to supplementary note 6, further including generating the plurality of pieces of time-series data by generating time-series data for each frequency band from measurement data of each sensor by using a Fourier transform.

### Supplementary Note 8

The analysis method according to supplementary note 6 or 7, wherein the one or more sensors include an acoustic emission (AE) sensor attached to the fiber rope, and a microphone attached around the fiber rope.

### Supplementary Note 9

The analysis method according to supplementary note 8, wherein the one or more sensors are attached at positions different from each other in an extending direction of the fiber rope.

### Supplementary Note 10

A program causing a computer to execute processing of analyzing a degree of damage of a fiber rope by using an invariant model indicating a relationship between a plurality of pieces of time-series data based on measurement data of one or more sensors attached to or around the fiber rope.

What is claimed is:

1. An analysis apparatus comprising:
at least one memory storing instructions and at least one processor configured to execute the instructions to;
analyze a degree of damage of a fiber rope by using an invariant model indicating a relationship between a plurality of pieces of time-series data based on measurement data of one or more sensors attached to or around the fiber rope.

2. The analysis apparatus according to claim 1, wherein the at least one processor is further configured to execute the instructions to:
generate the plurality of pieces of time-series data by generating time-series data for each frequency band from measurement data of each sensor by using a Fourier transform.

3. The analysis apparatus according to claim 1, wherein the one or more sensors include an acoustic emission (AE) sensor attached to the fiber rope, and a microphone attached around the fiber rope.

4. The analysis apparatus according to claim 3, wherein the one or more sensors are attached at positions different from each other in an extending direction of the fiber rope.

5. The analysis apparatus according to claim 1, wherein a repeated load is applied to the fiber rope.

6. An analysis method comprising analyzing a degree of damage of a fiber rope by using an invariant model indicating a relationship between a plurality of pieces of time-series data based on measurement data of one or more sensors attached to or around the fiber rope.

7. The analysis method according to claim 6, further comprising generating the plurality of pieces of time-series data by generating time-series data for each frequency band from measurement data of each sensor by using a Fourier transform.

8. The analysis method according to claim 6, wherein the one or more sensors include an acoustic emission (AE) sensor attached to the fiber rope, and a microphone attached around the fiber rope.

9. The analysis method according to claim 8, wherein the one or more sensors are attached at positions different from each other in an extending direction of the fiber rope.

10. A non-transitory computer-readable storage medium storing a program causing a computer to execute processing of analyzing a degree of damage of a fiber rope by using an invariant model indicating a relationship between a plurality of pieces of time-series data based on measurement data of one or more sensors attached to or around the fiber rope.
